(19) United States
(12) Patent Application Publication
(10) Pub. No.: US 2017/0119618 A1
(43) Pub. Date: May 4, 2017

(54) LOWER EYELID TREATMENT

(71) Applicant: KONINKLIJKE PHILIPS N.V, EINDHOVEN (NL)

(72) Inventors: MARTIN JURNA, EINDHOVEN (NL); CAECILIA HENDRINA THEODORA CHLON, EINDHOVEN (NL); JONATHAN ALAMBRA PALERO, EINDHOVEN (NL); ANTONIUS MAARTEN NUIJS, EINDHOVEN (NL); LINDA GOVERDINA MARIA BEIJENS, EINDHOVEN (NL)

(21) Appl. No.: 15/118,146

(22) PCT Filed: Jan. 29, 2015
(86) PCT No.: PCT/EP2015/051773

§ 371 Date: Aug. 11, 2016

(30) Foreign Application Priority Data
Mar. 20, 2014 (EP) 14160864.6

(51) Int. Cl. A61H 15/00

(52) U.S. Cl. CPC A61H 15/0085; A61H 2015/0014; A61H 2201/1215; A61H 2201/5071; A61H 2205/022

(57) ABSTRACT

The invention relates to a lower eyelid treatment device (1), which comprises a skin treatment structure (3) having a protruding shape which is able to perform a periodical first movement through a stationary reference point (P) in a skin treatment zone (8) of the device. Said periodical first movement occurs in the reference point (P) at a frequency within a frequency range between 0.5 Hz and 3.0 Hz. Said periodical first movement is a local movement of the protruding shape through the reference point (P), at a velocity in the reference point (P) within a velocity range between 0.005 m/sec and 0.05 m/sec, in a single local movement direction (12) in the reference point (P) being transverse to a local protrusion direction of the protruding shape. In this manner, the device provides a specific massage of eye bags of a treated person. The massage results in lymphatic drainage of fluid, which undesirably has built up in the skin of the lower eyelid area (52), towards (14) lymph nodes near the ear. Thus, the device provides a quickly and easily usable solution for reliably and effectively stimulating the reduction of eye bags.

### FIELD OF THE INVENTION

The invention relates to a lower eyelid treatment device. More specifically, the invention relates to a lower eyelid treatment device for reducing eye bags, which may occur under the eyes of human beings. The invention also relates to a cosmetic method for beautifying the appearance of lower eyelids, said method comprising the use of such a lower eyelid treatment device.

### BACKGROUND OF THE INVENTION

Eye bags under the human eyes are often visible in the morning. This morning puffiness is a transient form of eye bags. It is related to the retention of fluid during sleep. Often a specific lifestyle, characterized by things like lack of sleep and/or drinking alcohol and/or lack of exercise and/or eating salty meals, can worsen the appearance of this kind of eye bags.

Specific types of manual massage of, amongst others, the lower eyelid skin may stimulate the reduction of eye bags in terms of speed and/or extent of said reduction.

However, performing such a manual massage both reliably and effectively requires proper knowledge of the massage technique and it takes quite some time. Many people have neither the knowledge nor the time (especially during the morning rush hour) to perform a proper massage.

WO 2010/149959 A1 discloses a device for massaging the eyelids. The device comprises a rotatable massaging bobbin and a heater in thermal communication with the bobbin. The bobbin has a plurality of massaging elements extending from a concave external surface of the bobbin. In use, the bobbin is brought into contact with the eyelid, so that the bobbin heats the eyelid and rotates such that a massaging force is exerted on the eyelid perpendicular to the lash line and a massaging action is provided that is towards the lash line. The massaging force is used to express material from blocked sebaceous glands of the eyelid. The massaging elements comprise continuous narrow helical ridges extending around the periphery of the massaging bobbin, and scrubbing elements in the form of a plurality of deformable finger-like projections.

FR 2 947 723 A1 discloses a massaging device for massaging the eyelids. The device comprises a handle portion and a massaging head which is rotatably carried by a stationary shaft provided at a distal end of the handle portion. The massaging head comprises a plurality of protrusions. When the device is rolled over the skin surface, the massaging head is rotated about the stationary shaft. A vibrational source is provided in the handle portion to generate vibrations of the massaging head during use.

### SUMMARY OF THE INVENTION

It is an object of the invention to provide a solution which can be used quickly and easily by a person for reliably and effectively stimulating the reduction of eye bags in terms of speed and/or extent of said reduction.

For this purpose, the invention provides a lower eyelid treatment device, comprising:
an outer surface which comprises a handgrip area for manually holding the device;
a skin treatment structure for contacting a person's skin in a skin treatment zone of the device, said skin treatment zone having a reference point in a stationary position relative to the handgrip area, wherein at least part of the skin treatment structure is drivingly movable, as seen relative to said reference point;
an electrical energy source and/or an electrical energy supply connection;
a motor being electrically connected to the electrical energy source and/or to the electrical energy supply connection;
a movement mechanism being connected to the skin treatment structure for realizing a driven movement of the skin treatment structure relative to said reference point, said motor being drivingly connected to the movement mechanism;
a controller configured, arranged and effective to at least control said motor to drive said movement mechanism to move the skin treatment structure according to said driven movement;
   and wherein:
said driven movement of the skin treatment structure comprises a periodical first movement of a protruding shape of the skin treatment structure through said reference point, which protruding shape in the skin treatment zone locally protrudes outwards of the device in a local protrusion direction at least temporarily during said periodical first movement of the protruding shape through said reference point, wherein said periodical first movement is a local movement of the protruding shape through said reference point in a single local movement direction in the reference point transverse to the local protrusion direction of the protruding shape;
said periodical first movement through said reference point occurs in the reference point at a frequency within a frequency range between 0.5 Hz and 3.0 Hz; and
said local movement of the protruding shape through the reference point has a velocity in the reference point within a velocity range between 0.005 msec and 0.05 msec.

The device according to the invention can be manually held in such a manner that, in the skin treatment zone of the device, the skin treatment structure of the device lies against a lower eyelid area of a person's face. In that condition, the device in operation is able to provide a specific massage treatment to eye bags, which results in transport of fluid which undesirably has built-up in the skin of the lower eyelid area (lymphatic drainage). This transport of fluid is caused by the periodical first movement of the protruding shape of the skin treatment structure of the device, which protruding shape exerts pressure on the person's skin, while at the same time, seen in the reference point of the skin treatment zone of the device, it periodically moves through said reference position in said single local movement direction at a frequency and a velocity within the said frequency range and the said velocity range, respectively. In fact, each impression in the skin made by the protruding shape is comparable to an impression in the skin made by a fingertip of a person providing manual massage. Note that the device should preferably be held against the skin in an orientation such that said single local movemenet direction more or less corresponds to a direction extending from the lower eyelid area concerned towards the lymph nodes near the ear of the person being treated, which lymph nodes near the ear, in view of lymphatic drainage, correspond to the lower eyelid area concerned.

Hence, the device according to the invention provides a quickly and easily usable solution for reliably and effectively stimulating the reduction of eye bags.

Preferably, said periodical first movement through said reference point occurs in the reference point at a frequency within a frequency range between 1.0 Hz and 2.0 Hz.

Preferably, and in combination with any one of the above mentioned embodiments of the invention, said local movement of the protruding shape through the reference point has a velocity in the reference point within a velocity range between 0.01 m/sec and 0.025 m/sec.

In another preferable embodiment of the invention, which can be used in combination with any one of the above mentioned embodiments of the invention, the lower eyelid treatment device further comprises a pressure sensor configured, arranged and used to sense and/or measure a pressure at or within the device, said sensed and/or measured pressure being indicative of a pressure occurring between the protruding shape and an external object on which the protruding shape exerts pressure during operation of the device. Such a pressure sensor allows for monitoring the pressure exerted on the skin during the treatment with the device. During the massage treatment for reduction of the eye bags, the pressure exerted on the skin preferably is within a pressure range between 667 Pa and 10,000 Pa (i.e. between about 5 mmHg and about 75 mmHg), and more preferably within a pressure range between 4000 Pa and 5333 Pa (i.e. between about 30 mmHg and about 40 mmHg). The device may be configured, arranged and effective to warn users, based on said sensed and/or measured pressure, about certain situations in which too high and/or too low a pressure is being applied as compared to a considered preferential pressure range. Additionally or alternatively, the device may be provided with an active feedback structure such that the device may be configured, arranged and effective to automatically adjust one or more of its various operational parameters, based on said sensed and/or measured pressure.

In another preferable embodiment of the invention, which can be used in combination with any one of the above mentioned embodiments of the invention, the lower eyelid treatment device further comprises a velocity sensor configured, arranged and effective to sense and/or measure a velocity at or within the device, said sensed and/or measured velocity being indicative of a relative velocity occurring between the protruding shape and an external object on which the protruding shape exerts pressure during operation of the device. Such a velocity sensor allows for monitoring the relative velocity occurring between the protruding shape and the skin on which the protruding shape exerts pressure during operation of the device. The device may be configured, arranged and effective to warn users, based on said sensed and/or measured velocity, about certain situations in which too high and/or too low a relative velocity occurs as compared to a considered preferential velocity range. Additionally or alternatively, the device may be provided with an active feedback structure such that the device may be configured, arranged and effective toautomatically adjust one or more of its various operational parameters based on said sensed and/or measured velocity.

For example, for situations in which a treating person manually moves the device being operated over a person's skin, the velocity sensor may be configured, arranged and effective to sense and/or measure a relative velocity between the handgrip area of the device and a person's skin. It is noted that such sensing and/or measuring of the relative velocity between the handgrip area of the device and the person's skin is a form of obtaining an indication of the relative velocity between the protruding shape and the person's skin in that this relative velocity between the protruding shape and the person's skin is a superposition of this sensed and/or measured relative velocity between the handgrip area and the skin, on the one hand, and the known operational velocity of the protruding shape relative to the reference point or handgrip area, on the other hand.

In another preferable embodiment of the invention, which can be used in combination with any one of the above mentioned embodiments of the invention, a maximum protrusion length by which said protruding shape, during said periodical first movement, locally protrudes outwards of the device in the skin treatment zone is within a protrusion range between 0.00005 m and 0.005 m.

In another preferable embodiment of the invention, which can be used in combination with any one of the above mentioned embodiments of the invention, the skin treatment structure further comprises a spacer which sets the maximum protrusion length by which said protruding shape, during said periodical first movement, locally protrudes outwards of the device in the skin treatment zone, said spacer being removable from the device and/or adjustable to different fixed positions relative to other parts of the device for allowing users to set different values of said maximum protrusion length. Such a spacer provides ease, reliability and flexibility as to the obtainable skin impression depth created by the protruding shape of the device.

In another preferable embodiment of the invention, which can be used in combination with any one of the above mentioned embodiments of the invention, said driven movement of the skin treatment structure further comprises, in addition to said periodical first movement, a reciprocating second movement of said protruding shape relative to said reference point, wherein said reciprocating second movement has a reciprocation frequency within a reciprocation frequency range between 0.5 Hz and 200 Hz, and wherein said reciprocating second movement can be performed simultaneously and/or non-simultaneously with said periodical first movement. Such a reciprocating second movement of said protruding shape further improves drainage of fluid, particularly by further improving microcirculation of both the lymph and blood fluid.

In another preferable embodiment of the invention, which can be used in combination with any one of the above mentioned embodiments of the invention, said periodical first movement of the protruding shape through the reference point is part of a linear movement trajectory of the protruding shape in the skin treatment zone. Such a linear movement trajectory is favourable in view of the more or less linear lymphatic drainage trajectory from eye to ear.

Preferably, said skin treatment structure comprises a first roll, being rotatable around a first longitudinal axis of rotation and having an outer surface formed by at least one ridge being helically shaped around said first longitudinal axis of rotation, said ridge forming said protruding shape, which protruding shape thus follows said linear movement trajectory in the skin treatment zone when the first roll is being rotated around its first longitudinal axis of rotation, said linear movement trajectory being parallel to said first longitudinal axis of rotation. Such a first roll with such a helically shaped ridge provides a reliable and compact means for the protruding shape to follow said linear movement trajectory. To avoid confusion, it is remarked that, in this preferable embodiment, it is not a particular material part of the skin treatment structure which is actually moving along the linear movement trajectory. After all, speaking in terms of the skin treatment structure, this skin treatment structure (i.e. the first roll) merely rotates around the first longitudinal axis of rotation. However, speaking in terms of the (visual) protruding shape of the skin treatment structure, the helical shape of the ridge ensures that a mere rotation of the skin treatment structure induces a linear movement of the (visual) protruding shape in a direction parallel to said first longitudinal axis of rotation.

In another preferable embodiment of the invention, which can be used in combination with any one of the above mentioned embodiments of the invention, said periodical first movement of the protruding shape through the reference point is part of a curved movement trajectory of the protruding shape in the skin treatment zone. Such a curved movement trajectory has the advantage that it may be realized in various non-complex ways.

Preferably, said skin treatment structure comprises a second roll, being rotatable around a second longitudinal axis of rotation and having an outer surface formed by at least one ridge having a ridge direction parallel to said second longitudinal axis of rotation, said ridge forming said protruding shape, which thus follows said curved movement trajectory in the skin treatment zone when the second roll is being rotated around its second longitudinal axis of rotation, said curved movement trajectory extending around said second longitudinal axis of rotation. Such a second roll with at least one such ridge is a very non-complex way of realizing the curved movement trajectory.

In another preferable embodiment of the invention, which can be used in combination with any one of the above mentioned embodiments of the invention, the skin treatment structure comprises a plurality of protruding shapes which are successively arranged with a constant distance between adjacent protruding shapes such that, when the skin treatment structure is moved according to said driven movement, the protruding shapes successively perform said local movement through the reference point in said single local movement direction in the reference point.

In another preferable embodiment of the invention, which can be used in combination with any one of the above mentioned embodiments of the invention, said protruding shape is formed by a distribution of bristles. Such a distribution of bristles provides a gentle massage effect, while being a cleansing means at the same time.

The invention may also be embodied in a cosmetic method for beautifying the appearance of lower eyelids, wherein a lower eyelid treatment device according to any one of the above mentioned embodiments is manually held by a treating person, while at the same time the protruding shape of the skin treatment structure of the device performs said periodical first movement, during which periodical first movement the protruding shape exerts pressure on the skin of a person being treated, which may be said treating person or another person, in at least a lower eyelid area of said skin. Said method may, for example, be a cosmetic method for beautifying the appearance of lower eyelids.

In a preferable embodiment of a cosmetic method according to the invention, simultaneously with said periodical first movement of the protruding shape exerting pressure on said skin, the treating person manually moves the device in such a manner that the skin treatment zone of the device moves in a direction from said lower eyelid area of the person being treated towards lymph nodes near the ear of the person being treated, which lymph nodes, in view of lymphatic drainage, correspond to the lower eyelid area concerned. By (slowly) moving the skin treatment zone of the device from the lower eyelid area towards the corresponding ear, the treating person further stimulates lymphatic drainage. During one treatment session, the user may perform said (slow) movement from the lower eyelid area towards the corresponding ear multiple times.

### BRIEF DESCRIPTION OF THE DRAWINGS

The abovementioned aspects and other aspects of the invention will be apparent from and elucidated with reference to the embodiments described hereinafter by way of non-limiting examples only and with reference to the schematic figures in the enclosed drawing.

FIG. 1 shows, in a perspective view, an example of a first embodiment of a lower eyelid treatment device according to the invention, the skin treatment structure of the device lying against the lower left eyelid area of a person's face.

FIG. 2A shows a portion of a cross-section of FIG. 1, said cross-section being taken transverse to the person's longitudinal direction at a longitudinal position where the skin treatment structure lies against the lower left eyelid area, and wherein the shown cross-sectional portion includes the skin treatment structure.

FIG. 2B shows another portion of another cross-section of FIG. 1, said other cross-section also being taken transverse to the person's longitudinal direction, however at a longitudinal position where a lymph node, near the person's left ear, is situated, and wherein this other cross-sectional portion includes said lymph node.

FIG. 3A shows the device of FIG. 1 in a longitudinal cross-section through the device.

FIG. 3B shows the device of FIG. 1 in a transverse cross-section taken along the plane indicated by arrows III B in FIG. 3A, wherein said plane is viewed in the direction of the arrows III B.

FIG. 4 shows, in a view similar to that of FIG. 3B, an example of a second embodiment of a lower eyelid treatment device according to the invention, wherein the skin treatment structure of this second embodiment comprises an additional spacer as compared to the embodiment of FIGS. 3A and 3B.

FIG. 5 shows, in a view similar to that of FIG. 4, an example of a third embodiment of a lower eyelid treatment device according to the invention, wherein the skin treatment structure of this third embodiment comprises another additional spacer as compared to the second embodiment of FIG. 4.

FIG. 6A shows an example of a fourth embodiment of a lower eyelid treatment device according to the invention in a longitudinal cross-section through the device.

FIG. 6B shows the device of FIG. 6A in a transverse cross-section taken along the plane indicated by arrows VI B in FIG. 6A, wherein said plane is viewed in the direction of the arrows VI B.

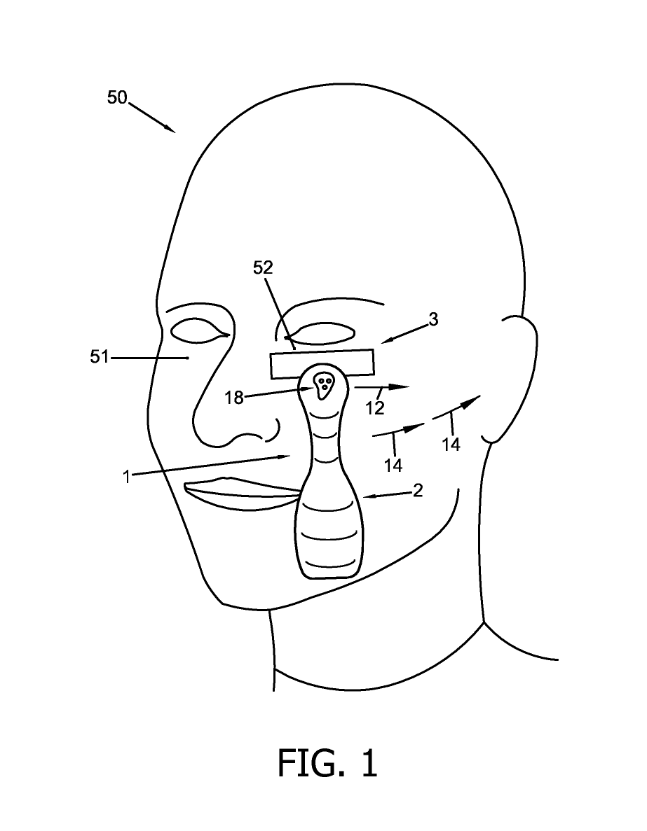

It is noted that, when the same reference signs are used throughout different FIGS. 1 through 6B) of the drawing, these reference signs denote the same or similar parts or aspects.

### DETAILED DESCRIPTION OF EMBODIMENTS

Reference is first made to FIGS. 1, 2A, 2B, 3A, 3B, which illustrate the above mentioned example of a first embodiment of a lower eyelid treatment device according to the invention. Based on this lower eyelid treatment device, which is indicated by reference numeral 1, FIGS. 1 through 3B furthermore illustrate an example of an embodiment of a method according to the invention.

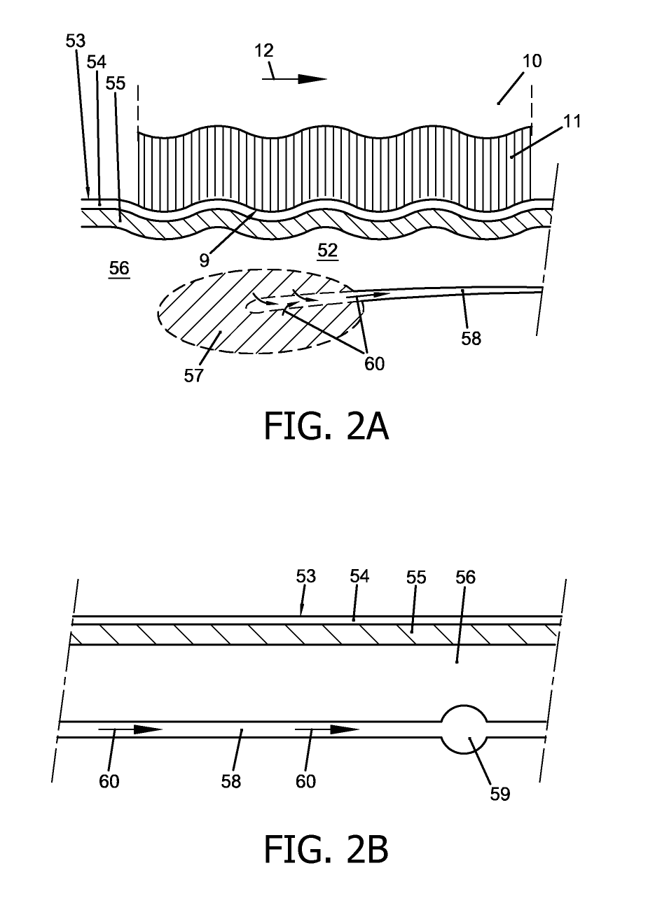

FIG. 1 shows the person 50 being treated, having a right lower eyelid 51 and a left lower eyelid 52. FIG. 2A shows the lower left eyelid area 52 of the person in cross-section, wherein the reference numerals 53, 54, 55, and 56 indicate the skin surface, the stratum corneum, the epidermis, and the subepidermis, respectively, of the person's skin. Within the subepidermis 56, lymphatic fluid 57 is present. FIG. 2A furthermore shows a lymphatic vessel 58, which, as shown in FIG. 2B, connects to a lymph node 59 located near the left ear of the person 50.

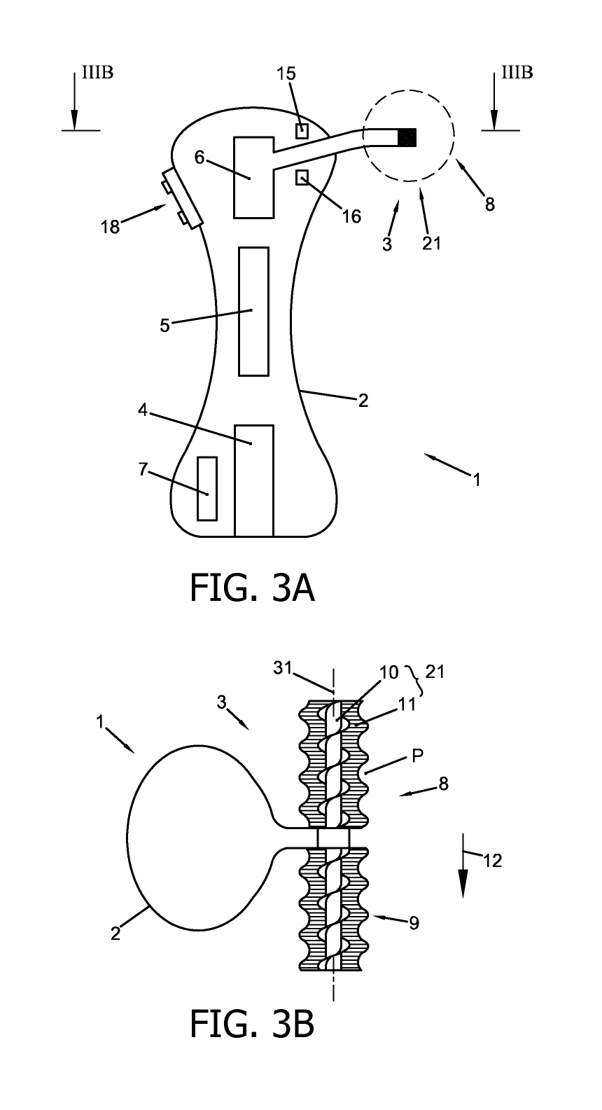

The above mentioned handgrip area and skin treatment structure of the device 1 are indicated by reference numerals 2 and 3, respectively, while reference numeral 8 (see FIGS. 3A and 3B) denotes the above mentioned skin treatment zone of the device 1, wherein a reference point P is present, shown in FIG. 3B, which is in a stationary position relative to the handgrip area 2. Furthermore, as seen in FIG. 3A, the above mentioned electrical energy source and/or electrical energy supply connection, motor, movement mechanism, and controller are indicated by reference numerals 4, 5, 6, and 7, respectively.

The shown device 1 also is an example of the above mentioned preferable embodiment of the invention, wherein said periodical first movement of the protruding shape through the reference point P is part of a linear movement trajectory of the protruding shape in the skin treatment zone 8. More in particular, the shown device 1 is an example of the above mentioned preferable embodiment of the invention, wherein said skin treatment structure comprises a first roll, being rotatable around a first longitudinal axis of rotation and having an outer surface formed by at least one ridge being helically shaped around said first longitudinal axis of rotation, said ridge forming said protruding shape, and said protruding shape thus following said linear movement trajectory in the skin treatment zone when the first roll is rotated around its first longitudinal axis of rotation, said linear movement trajectory being parallel to said first longitudinal axis of rotation. In FIG. 3B, for the shown device 1, said first roll, said first longitudinal axis of rotation, and said protruding shape formed by said helically shaped ridge are indicated by the reference numerals 21, 31, and 9, respectively. The movement mechanism 6 is connected to the first roll 21 so as to cause rotation of this first roll 21 around the first longitudinal axis of rotation 31 relative to the stationary reference point P.

The shown device 1 also is an example of the above mentioned preferable embodiment of the invention, wherein said protruding shape is formed by a distribution of bristles. In FIGS. 3B and 2A, these bristles are indicated by reference numeral 11. In fact, as seen in said FIGS. 3B and 2A, the first roll 21 comprises a helically shaped core body 10, as well as these bristles 11, which are attached to the core body 10.

In FIGS. 1, 2A and 3B, the above mentioned single local movement direction of the protruding shape 9 is indicated by reference numeral 12. FIG. 2A illustrates the directional massage treatment of the skin, wherein the single local movement direction 12 of the protruding shape 9, making an impression in the skin, causes the fluid 57 to enter into the lymphatic vessel 58, and subsequently induces lymphatic drainage of thefluid 57 through the lymphatic vessel 58. In FIGS. 2A and 2B, the drainage directions are indicated by reference numeral 60. As a result of the single local movement direction 12 of the protruding shape 9 in the skin treatment zone 9, drainage takes place in a single direction towards the left ear of the person 50, i.e. in the direction of the lymph node 59 shown in FIG. 2B.

Some suitable example data pertaining to the device 1 may be as follows: the first roll 21 has an overall outer diameter of about 10 mm, and a length of about 40 mm (measured along the first longitudinal axis of rotation 31). In the example shown, the first roll 21 furthermore has one helically shaped ridge, which has a pitch of about 10 mm. It is noted that, in the example shown, this helically shaped ridge extends throughout the entire length of the first roll 21, however, as seen in FIG. 3B, it has an interruption about halfway the length of the first roll 21 for allowing the movement mechanism 6 to be connected to the first roll 21 so as to rotate the first roll around the first longitudinal axis of rotation 31. The maximum protrusion length by which the helically shaped protruding shape 9, during said periodical first movement, locally protrudes outwards of the device 1 in the skin treatment zone 8 is about 3 to about 4 mm. In a typical operation condition, the rotation frequency of the first roll 21 is about 1 Hz. From said pitch and said rotation frequency, it can be derived that the local movement of the protruding shape 9 through the reference point P in the single local movement direction 12 occurs at a velocity of about 10 mm/sec. Since, in this case, the first roll 21 has only one helically shaped ridge, the above mentioned periodical first movement of the protruding shape 9 through the reference point P occurs in the reference point P at a frequency equal to the above mentioned rotation frequency of the first roll 21, i.e. at about 1 Hz. It is noted that, in case the first roll would have a multiple of n equally spaced helically shaped ridges (similar to a multi-bladed screw propeller), the above mentioned periodical first movement of the protruding shape 9 through the reference point P would occur in the reference point P at a frequency which is a factor of n times the rotation frequency of the first roll 21.

The arrows 14, shown in FIG. 1, illustrate the direction in which a treating person may, if desired, additionally move the device 1 from the left lower eyelid area 52 towards the node 59 near the left ear of the person being treated 50, thus inducing an additional movement 14 relative to the person's skin, i.e. in addition to the local movement of the protruding shape 9, as already explained, in the single local movement direction 12 relative to the person's skin.

The shown device 1 also is an example of the above mentioned preferable embodiment of the invention, wherein the lower eyelid treatment device further comprises a pressure sensor configured, arranged and effective to sense and/or measure a pressure at or within the device, said sensed and/or measured pressure being indicative of a pressure occurring between the protruding shape and an external object on which the protruding shape exerts pressure during operation of the device. In FIG. 3A, this pressure sensor is indicated by reference numeral 15.

The shown device 1 also is an example of the above mentioned preferable embodiment of the invention, wherein the lower eyelid treatment device further comprises a velocity sensor configured, arranged and effective to sense and/or measure a velocity at or within the device, said sensed and/or measured velocity being indicative of a relative velocity occurring between the protruding shape and an external object on which the protruding shape exerts pressure during operation of the device. In FIG. 3A, this velocity sensor is indicated by reference numeral 16.

FIG. 3A furthermore shows that the device comprises a user interface 18, which may comprise various elements like an on/off button, selection buttons, a visual display, and the like. For example, the user interface may comprise a switch to change the direction of rotation of the first roll 21, which enables a user to alternate between the local movement direction 12 of the protruding shape shown in FIGS. 1 and 3B (for treating the left lower eyelid 52 in FIG. 1) and a local movement direction which is opposite to the local movement direction 12 for treating the right lower eyelid 51 in FIG. 1.

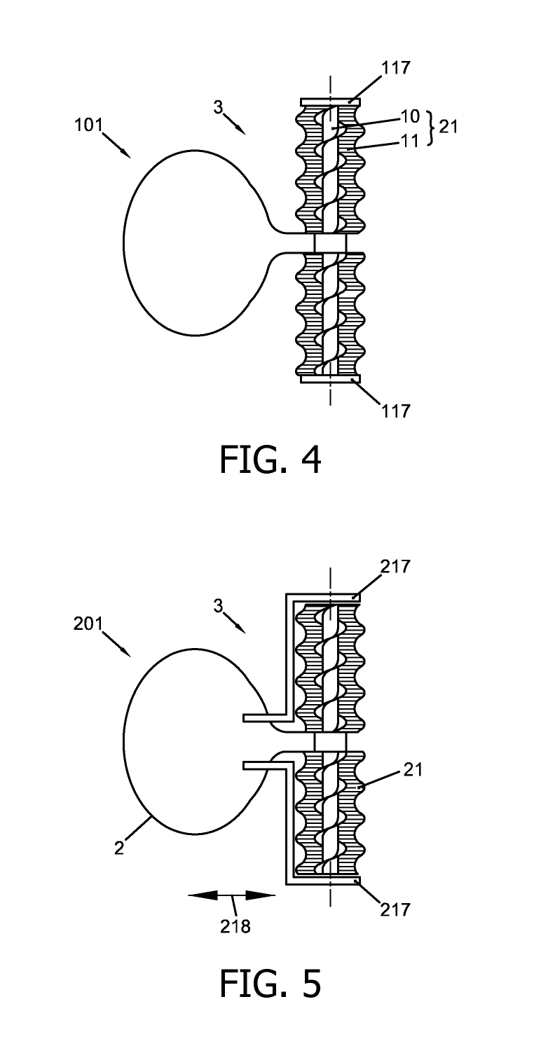

Reference is now made to FIG. 4, which illustrates the above mentioned example of a second embodiment of a lower eyelid treatment device according to the invention. This device 101 of FIG. 4 is an example of the above mentioned preferable embodiment of the invention, wherein the skin treatment structure further comprises a spacer which sets the maximum protrusion length by which said protruding shape, during said periodical first movement, locally protrudes outwards of the device in the skin treatment zone. In the example of FIG. 4, the spacer is formed by two circular discs 117 which are transversely attached to the two longitudinal ends of the first roll 21, respectively. In the shown example, the two circular discs 117 are removable from the first roll 21.

Reference is now made to FIG. 5, which illustrates the above mentioned example of a third embodiment of a lower eyelid treatment device according to the invention. This device 201 of FIG. 5 is an example of the above mentioned preferable embodiment of the invention, wherein the skin treatment structure further comprises a spacer which sets the maximum protrusion length by which said protruding shape, during said periodical first movement, locally protrudes outwards of the device in the skin treatment zone. In the example of FIG. 5 the spacer is formed by a housing element 217. In the shown example, the location of the housing element 217 is adjustable, in the indicated directions 218, into different fixed positions relative to other parts of the device, including the first roll 21, for allowing users to set different values of said maximum protrusion length.

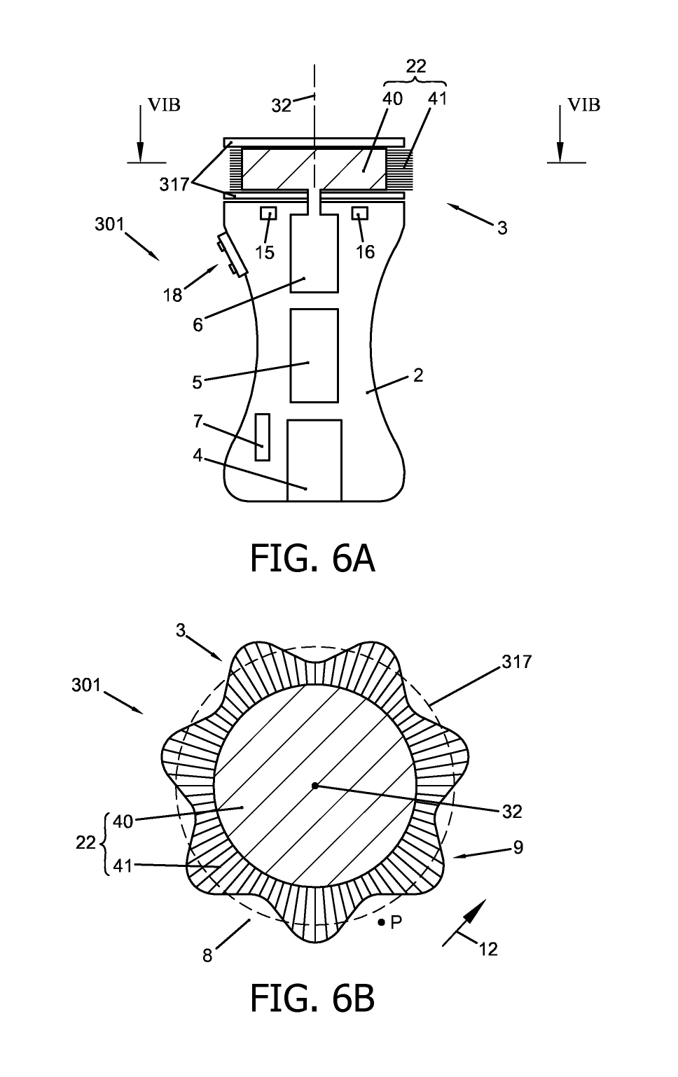

Reference is now made to FIGS. 6A and 6B, which illustrate the above mentioned example of a fourth embodiment of a lower eyelid treatment device according to the invention. The device 301 of FIGS. 6A and 6B is an example of the above mentioned preferable embodiment of the invention, wherein said periodical first movement of the protruding shape through the reference point P is part of a curved movement trajectory of the protruding shape in the skin treatment zone. More in particular, the device 301 of FIGS. 6A and 6B is an example of the above mentioned preferable embodiment of the invention, wherein said skin treatment structure comprises a second roll, being rotatable around a second longitudinal axis of rotation and having an outer surface formed by at least one ridge having a ridge direction parallel to said second longitudinal axis of rotation, said ridge forming said protruding shape, which thus follows said curved movement trajectory in the skin treatment zone when the second roll is being rotated around its second longitudinal axis of rotation, said curved movement trajectory extending around said second longitudinal axis of rotation.

In FIGS. 6A and 6B, for the shown device 301, said second roll, said second longitudinal axis of rotation, and said protruding shape are indicated by the reference numerals 22, 32, and 9, respectively. The reference point P in the treatment zone 8, shown in FIG. 6B, is in a stationary position relative to the handgrip area 2. The movement mechanism 6 is connected to the second roll 22 so as to rotate this second roll 22 around the second longitudinal axis of rotation 32 relative to the stationary reference point P.

The shown device 301 also is an example of the above mentioned preferable embodiment of the invention, wherein said protruding shape 9 is formed by a distribution of bristles. In FIGS. 6A and 6B these bristles are indicated by reference numeral 41. In fact, as seen in FIGS. 6A and 6B, the second roll 22 comprises a cylindrically-shaped core body 40, in addition to these bristles 41 which are attached to the core body 40. In the view of FIG. 6B, the second roll 22 has the appearance of a star-shaped body, thus forming a plurality of equally spaced protruding shapes 9. Accordingly, the above mentioned periodical first movement of the protruding shapes 9 through the reference point P occurs in the reference point P at a frequency equal to the rotational frequency of the rotational movement of the second roll 22 around the second longitudinal axis of rotation 32, multiplied by the number of protruding shapes 9 comprised in a cross-sectional view similar to that of FIG. 6B. In this embodiment, said periodical first movement of each protruding shape 9 through the reference point P is a local movement of the protruding shape 9 through the reference point P in a single local movement direction 12 in the reference point P, which corresponds to the local tangential movement direction of the protruding shape 9 in the reference point P as part of the rotating second roll 22, and which has a velocity in the reference point P equal to the local tangential velocity of the protruding shape 9 in the reference point P as part of the rotating second roll 22.

The shown device 301 also is an example of the above mentioned preferable embodiment of the invention, wherein the skin treatment structure further comprises a spacer which sets the maximum protrusion length by which said protruding shape, during said periodical first movement, locally protrudes outwards of the device in the skin treatment zone. In the example of FIGS. 6A and 6B, the spacer is formed by two circular discs 317 which are transversely attached to the two longitudinal ends of the second roll 22, respectively. In the example shown, the two circular discs 317 are removable from the second roll 22. In connection with this fourth embodiment, alternative spacers are possible, which are adjustable into different fixed positions relative to other parts of the device for allowing users to set different values of said maximum protrusion length.

While the invention has been described and illustrated in detail in the foregoing description and in the drawing figures, such description and illustration are to be considered exemplary and/or illustrative and not restrictive; the invention is not limited to the disclosed embodiments.

For example, in the examples shown, the protruding shapes 9 are formed by distributions of bristles 11. According to the invention, however, it is possible to apply, instead of such distributions of bristles, various other kinds of structures forming protruding shapes. For example, instead of applying the bristles in the shown helically shaped first roll 21 or in the shown star-shaped second roll 22, the helically shaped first roll or the star-shaped second roll may be formed in one piece of a solid material, with the protruding shapes formed integrally with the first roll or second roll. Such a material may be a resilient material (such as rubber) or a non-resilient material (e.g. a metal).

Furthermore, embodiments of devices according to the invention are possible, wherein the skin treatment zone of the skin treatment structure comprises multiple different skin treatment zones with corresponding multiple different local movement directions of corresponding multiple different moving protruding shapes. To mention an example of such an embodiment, it is noted that a device according to the invention may comprise two such skin treatment zones, which are suitable for simultaneous treatment of the lower left eyelid area and the lower right eyelid area of a person's skin, respectively. Such a device may be operable in such a manner that the simultaneously induced two local movement directions in the two skin treatment zones are mutually opposite for drainage in a direction from the left eye towards the left ear and in a direction from the right eye towards the right ear, respectively.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. For the purpose of clarity and a concise description, features are disclosed herein as part of the same or separate embodiments, however, it will be appreciated that the scope of the invention may include embodiments having combinations of all or some of the features disclosed. The mere fact that certain measures are recited in mutually different dependent claims does not indicate that a combination of these measures cannot be used to advantage. Any reference signs in the claims should not be construed as limiting the scope.

1. A lower eyelid treatment device, comprising:
an outer surface which comprises a handgrip area (2) for manually holding the device (1; 101; 201; 301);
a skin treatment structure (3) for contacting a person's skin in a skin treatment zone (8) of the device, said skin treatment zone (8) having a reference point (P) in a stationary position relative to the handgrip area (2), wherein at least part of the skin treatment structure is drivingly movable, as seen relative to said reference point (P);
an electrical energy source (4) and/or an electrical energy supply connection;
a motor (5) being electrically connected to the electrical energy source and/or to the electrical energy supply connection;
a movement mechanism (6) being connected to the skin treatment structure for realizing a driven movement of the skin treatment structure relative to said reference point (P), said motor being drivingly connected to the movement mechanism;
a controller (7) configured, arranged and effective to at least control said motor to drive said movement mechanism to move the skin treatment structure according to said driven movement;
and wherein:
said driven movement of the skin treatment structure comprises a periodical first movement of a protruding shape (9) of the skin treatment structure through said reference point (P), which protruding shape in the skin treatment zone locally protrudes outwards of the device in a local protrusion direction at least temporarily during said periodical first movement of the protruding shape through said reference point (P), wherein said periodical first movement is a local movement of the protruding shape through said reference point (P) in a single local movement direction (12) in the reference point (P) transverse to the local protrusion direction of the protruding shape;
said periodical first movement through said reference point (P) occurs in the reference point (P) at a frequency within a frequency range between 0.5 Hz and 3.0 Hz; and
said local movement of the protruding shape through the reference point (P) has a velocity in the reference point (P) within a velocity range between 0.005 m/sec and 0.05 m/sec.

2. A lower eyelid treatment device according to claim 1, wherein said periodical first movement through said reference point (P) occurs in the reference point (P) at a frequency within a frequency range between 1.0 Hz and 2.0 Hz.

3. A lower eyelid treatment device according to claim 1 or 2, wherein said local translational movement of the protruding shape (9) through the reference point (P) has a velocity in the reference point (P) within a velocity range between 0.01 m/sec and 0.025 m/sec.

4. A lower eyelid treatment device according to any one of the preceding claims, further comprising a pressure sensor (15) configured, arranged and used to sense and/or measure a pressure at or within the device, said sensed and/or measured pressure being indicative of a pressure occurring between the protruding shape (9) and an external object on which the protruding shape exerts pressure during operation of the device.

5. A lower eyelid treatment device according to any one of the preceding claims, further comprising a velocity sensor (16) configured, arranged and effective to sense and/or measure a velocity at or within the device, said sensed and/or measured velocity being indicative of a relative velocity occurring between the protruding shape (9) and an external object on which the protruding shape exerts pressure during operation of the device.

6. A lower eyelid treatment device according to any one of the preceding claims, wherein a maximum protrusion length by which said protruding shape (9), during said periodical first movement, locally protrudes outwards of the device in the skin treatment zone (8) is within a protrusion range between 0.00005 m and 0.005 m.

7. A lower eyelid treatment device according to any one of the preceding claims, wherein the skin treatment structure (3) further comprises a spacer (117; 217; 317) which sets the maximum protrusion length by which said protruding shape (9), during said periodical first movement, locally protrudes outwards of the device in the skin treatment zone, said spacer being removable from the device and/or adjustable into different fixed positions relative to other parts of the device for allowing users to set different values of said maximum protrusion length.

8. A lower eyelid treatment device according to any one of the preceding claims, wherein said driven movement of the skin treatment structure (3) further comprises, in addition to said periodical first movement, a reciprocating second movement of said protruding shape (9) relative to said reference point (P), wherein said reciprocating second movement has a reciprocation frequency within a reciprocation frequency range between 0.5 Hz and 200 Hz, and wherein said reciprocating second movement can be performed simultaneously and/or non-simultaneously with said periodical first movement.

9. A lower eyelid treatment device according to any one of the preceding claims, wherein said periodical first movement of the protruding shape through the reference point (P) is part of a linear movement trajectory of the protruding shape (9) in the skin treatment zone (8).

10. A lower eyelid treatment device according to claim 9, wherein said skin treatment structure comprises a first roll (21), being rotatable around a first longitudinal axis of rotation (31) and having an outer surface formed by at least one ridge being helically shaped around said first longitudinal axis of rotation, said ridge forming said protruding shape (9), which protruding shape thus follows said linear movement trajectory (12) in the skin treatment zone when the first roll is being rotated around its first longitudinal axis of rotation, said linear movement trajectory being parallel to said first longitudinal axis of rotation (31).

11. A lower eyelid treatment device according to any one of the preceding claims, wherein said periodical first movement of the protruding shape through the reference point (P) is part of a curved movement trajectory of the protruding shape (9) in the skin treatment zone (8).

12. A lower eyelid treatment device according to claim 11, wherein said skin treatment structure comprises a second roll (22), being rotatable around a second longitudinal axis of rotation (32) and having an outer surface formed by at least one ridge having a ridge direction parallel to said second longitudinal axis of rotation, said ridge forming said protruding shape (9), which thus follows said curved movement trajectory in the skin treatment zone when the second roll is being rotated around its second longitudinal axis of rotation, said curved movement trajectory extending around said second longitudinal axis of rotation.

13. A lower eyelid treatment device according to any one of the preceding claims, wherein the skin treatment structure (3) comprises a plurality of protruding shapes (9) which are successively arranged with a constant distance between adjacent protruding shapes such that, when the skin treatment structure is moved according to said driven movement, the protruding shapes successively perform said local movement through the reference point (R) in said single local movement direction (12) in the reference point (P).

14. A lower eyelid treatment device according to any one of the preceding claims, wherein said protruding shape (9) is formed by a distribution of bristles (11).

15. A cosmetic method for beautifying the appearance of lower eyelids (51, 52), wherein a lower eyelid treatment device (1; 101; 201; 301) according to any one of the preceding claims is manually held by a treating person, while at the same time the protruding shape (9) of the skin treatment structure (3) of the device performs said periodical first movement, during which periodical first movement the protruding shape exerts pressure on the skin of a person being treated (50), which may be said treating person or another person, in at least a lower eyelid area (52) of said skin.

16. A cosmetic method according to claim 15, wherein, simultaneously with said periodical first movement of the protruding shape (9) exerting pressure on said skin, the treating person manually moves the device (1) in such a manner that the skin treatment zone (8) of the device moves in a direction (14) from said lower eyelid area (52) of the person being treated towards the lymph nodes (59) near the ear of the person being treated, which lymph nodes, in view of lymphatic drainage, correspond to the lower eyelid area (52) concerned.
